(19) United States
(12) Patent Application Publication
(10) Pub. No.: US 2007/0180764 A1
(43) Pub. Date: Aug. 9, 2007

(54) Formwork for landscape edging

(76) Inventors: Craig Antony Forman, Auckland (NZ); Stephen Rex Brooke-Taylor, Blenheim (NZ)

Correspondence Address: YOUNG & THOMPSON, 745 SOUTH 23RD STREET, 2ND FLOOR, ARLINGTON, VA, 22202, US

(21) Appl. No.: 11/488,136

(22) Filed: Jul. 18, 2006

(30) Foreign Application Priority Data
Feb. 7, 2006 (NZ) 545 166
Feb. 15, 2006 (NZ) 545 376

(51) Int. Cl. A01G 1/08

(52) U.S. Cl. 47/33

(57) ABSTRACT

A system of formwork guides of consistent width and depth but of various lengths; some of which provide bends or curves or junctions is developed for easier laying of garden and landscaping edges of the type having a concrete base (and optional masonry on top). The system of guides comprises prefabricated sacrificial shuttering that delimits straight and curved edging. The guides can be cut to suit a layout. Preferred guides are U-shaped channels of vacuum-formed moulded plastic sheeting. Cross-bridging formations within the guides help maintain the walls upright and can be used to hold optional reinforcing metal rods and/or optional pipes or cables in place until concrete has been poured.

### FIELD

This invention relates to components for use when creating edging on the ground in a landscape, garden, playground or the like; more particularly the invention relates to prefabricated edging that serves to restrain concrete (or mortar) poured into laid-out edging to make a concrete linear structure, (which may become a base for a wall).

### BACKGROUND

This invention relates to the matter of making an edging for use in lawns and by landscapers in order to separate one area from another. Previous methods for doing this include:
1. Use of strips of wood or other material laid along a line, forming an edge.
2. No base, perhaps a trench. A line of bricks, or other masonry, or rocks is embedded in a trench or is simply placed on the ground. Movement and penetration by invasive plants are two common problems resulting in early deterioration.
3. Pouring concrete inside removable wooden boxing. This is labour intensive. The concrete might be wide enough to serve as a path. It might include reinforcing.
4. Pouring concrete inside vertically oriented rubber-like strips, which have been pegged in place before pouring, and which tends to form wiggly edges where the edges are forced apart.
5. Extruding concrete by means of a proprietary machine known as a curbing machine, which extrudes a continuous column/strip of concrete/mortar into a trench or onto the ground. (Costs per lineal foot are significant, and internal reinforcing is difficult to include).

The methods that place concrete along edges may be decorated or supplemented with such as masonry—bricks laid either along or across the concrete in one course or more. Selection of any one method depends to some extent on the degree of permanence required, the amount of skill available, and whether the labour involved has a cost.

The above methods have not solved the problem of providing a strong, durable, neatly finished edging, one for which the prefabricated components to be used are light in weight.

### PRIOR ART

There are a number of patent publications in relation to landscape edging in general. Allen et al. in U.S. Pat. No. 6,629,383 describes a landscape-edging used to segregate dissimilar landscaping schemes by positioning the device into the soil. Like many others, the invention is made of flexible strips, designed for continuous end-to-end attachment and is attached to the soil by removably attached stakes. The edging system is designed so that stakes are part of the edging portion of the device. The width of the result tends to vary, since the weight of concrete tends to push the sides apart if no restraining stake is present resulting in wiggly edges as mentioned previously. Staten et al. in U.S. Pat. No. 6,591,547 describes another family of edging products: wherein the material sold is pre-formed blocks; in this example having bidirectional, interlocking joints. Foster in U.S. Pat. No. 6,625,925 describes yet another kind of landscape ending, in which a modular extended bent panel having a decorative outer surface is joined lengthways with others, and mulch etc may be concealed within the bend. McIntyre et al. in U.S. Pat. No. 6,324,783 describes an integrally moulded plastic landscape edging strip with integrally moulded spikes to penetrate the ground. Ireland in U.S. Pat. No. 4,647,491 described use of fluted board (one common form being made in polypropylene), cut into strips so that the flutes will lie vertical, then simply staked into the ground using pegs passing through the flutes. Hairpin pegs join strips edge-to-edge.

### OBJECT

It is an object of this invention to provide a landscaping guide or formwork for the in-situ pouring of edging, or at least to provide the public with a useful choice.

### STATEMENT OF INVENTION

In a first broad aspect this invention provides formwork for a horticultural, garden or landscape edging laid down on or in the substrate or soil, suitable for delimiting one area from another, wherein the edging system comprises a generally U-shaped channel unit having a defined width and sufficient lateral strength to maintain the width while holding a settable fluid material selected from a range including (without limitation) cement and mortar within the channel until the fluid material has set.

Preferably the base and sides of the channel unit are located in relation to the substrate or soil prior to hardening of the settable fluid material by being placed within a shallow trench cut into the substrate.

Alternatively the base and sides of the channel unit are temporarily located prior to hardening of the settable fluid material by placement of a plurality of holding frames placed on or in the substrate.

Alternatively the base and sides of the channel unit are temporarily located prior to hardening of the settable fluid material by transfixment using fastening means forced into the substrate.

In a first related aspect, the invention provides formwork including a channel unit having a generally U-shaped cross-section comprised of a base and two sides extending upwardly from the base, and including at least one transverse bridge arranged in use to extend transversely across the channel unit between the two sides.

Preferably the formwork includes a plurality of said channel units, wherein each channel unit has at least one open end, and the ends are mutually engageable in order to define a continuous channel along a plurality of said units.

Preferably each bridge includes at least one aperture in or under each said bridge between a top surface of the bridge and the base of the channel unit, so that in normal use settable fluid contained within the channel unit can flow under the bridge and merge with settable fluid within the item of formwork and beyond the bridge.

Preferably each bridge has a top edge including at least one notch or like locating means for locating at least one elongated member within the settable composite; the or each elongated member comprising one or more of a range including: a beam of reinforcing steel for tensile reinforcement purposes, a pipe, or a cable.

Preferably the the two sides of the channel unit have top edges and the bridge has a top surface, the top surface being entirely below the top edges, so that in normal use the bridge can be entirely immersed in a settable fluid contained between the two sides.

Alternatively the top surface of the bridge is (when in use) at a level substantially the same as that of the top edges, so that when in use the bridge can serve as a crack former during curing of the settable fluid material.

Preferably the or each bridge comprises an integrally formed component of the channel unit.

Optionally the or each bridge comprises a separately fabricated insert capable of being laid within the channel unit either by virtue of conforming to the interior profile of the channel unit, or being engageable with the interior of the channel unit.

Optionally the channel units are provided with asymmetric walls including a version where one side is higher than the other.

Preferably the base of each channel unit includes at least one aperture, so that when in use part of the settable fluid material can flow out through the base and form a contact with the substrate, thereby relieving the formwork of the weight of the settable fluid material.

Preferably the apertures comprising at least 15% of the total base area; and more preferably the apertures comprising at least 65% of the total base area.

In a version of the formwork having removable side shutters, there is no base and the aperture percentage is then substantially 100%.

In a first version, the formwork includes at least one elongate channel unit having two open ends facing in opposite directions, defining a substantially straight channel between said ends.

In a second version, the formwork includes at least one corner channel unit having two open ends, one said end being arranged tangentially with respect to the other.

In a first subsidiary version, the corner channel unit is comprised of a first substantially straight section having two open ends; the first section having a second section joined to the first section between the open ends so that a “T” junction having a third open end is provided.

In a second subsidiary version, the corner channel unit is comprised of two substantially straight sections joined tangentially so that a sharp elbow or corner is formed between two open ends.

Preferably an angle formed between the ends as a result is in a range of from about 30 degrees to about 120 degrees.

In a third version, the corner channel unit is curved about a substantially vertical axis; the corner channel unit having two open ends and one end is bent around the curve at an angle in a range of from about 15 degrees to about 120 degrees in relation to the other.

In a fourth version, the corner channel unit is curved about a substantially horizontal axis; the channel unit having two open ends, one said end being arranged at an angle in a range of from about 5 degrees to about 45 degrees to the other.

In a second related aspect, the invention provides formwork for which the base and sides of the channel unit are formed from an indefinite length of a flexible, corrugated material, so that, when in use the corrugations can be compressed together on one side of the channel unit and stretched out on the other, to flex the channel unit about an axis yet maintain a substantially constant width between the sides of the channel unit.

Preferably the axis is substantially vertical, substantially horizontal, or at an angle dictated by the profile of the substrate.

In a third related aspect, the invention provides formwork wherein the base and sides of the channel unit are formed from a chain of interlinked segments, each segment having at least two walls extended outwardly thereby permitting loosely controlled attachment to adjacent segments, thereby allowing tilting of one segment in relation to an adjacent segment, so that in use the chain of segments can be assembled as a channel unit yet may curve in horizontal or vertical axes.

In a fourth related aspect the formwork provides for at least partial disposal of the walls after the settable material has set into a solid form.

In a first version, the sides have shapes permitting subsequent removal and re-use of the sides after the settable material has cured sufficiently.

In a second version, the sides are formed of a material permitting degradation of the sides after the settable material has cured sufficiently; degradation proceeding by corrosion or rotting.

In a third version, the sides are formed of a material permitting hand or machine tearing, cutting or stripping of the sides or at least that part visible above the substrate.

In a second broad aspect, the invention provides a method for creating an edging, wherein the method includes the steps of:
a. marking out a course upon a substrate along which the edging is to run;
b. fitting straight, flexible or bent formwork into the course, the formwork comprising a channel unit having a generally U-shaped cross-section comprised of a base and two sides extending upwardly from the base, and a plurality of bridges extending between the sides, above the base,
c. pouring a settable fluid material into the formwork to fill the channel unit,
d. and screeding the top surface to provide a suitable finish.

Optionally the top surface of the concrete may be provided with a drainage channel.

In one option, the top surface, while wet, is finished with a roller bearing a curved surface capable of imprinting a channel.

Optionally a roller is provided capable of imprinting one of a variety of decorative and/or useful patterns or shapes on a wet top surface.

Optionally any visible channel unit material is later stripped from the concrete.

Optionally, one or more courses of masonry or other wall material is/are placed over the concrete once the settable fluid material has hardened, or while still wet.

A method as described above, further including the step of placing at least one elongate member along said bridges before pouring the settable fluid material, to a level above the level of the bridges and the elongate member or members; the elongate member or members being selected from a range including (a) reinforcing steel bars, (b) pipes, and (c) electrical or optical cables.

A method as claimed in claim 25, further including the step of removing at least an upper part of the sides after the fluid material has set.

In a third broad aspect, the channel units are made by cutting and pressing a sheet of degradable corrugated board made of a formable material in a configuration wherein a sandwich of corrugated material is provided with a flat surface on at least one side.

In a fourth subsidiary aspect the moulding process comprises provision of a mould on which a wet cellulose-rich material is placed and dried into a U-shaped channel unit; the material including paper mache.

Preferred materials include a cardboard or papier mache treated in order to provide temporary water-resistant properties.

In an alternative aspect, the channel units are made in a metal or plastics material by a forming process selected from a range including (without limitation): injection moulding, rolling or extrusion (possibly with subsequent stamping), rotational moulding, and vacuum forming.

In a further alternative aspect, the channel units are made by pressing and deforming a deformable material (including thin sheets of a metal).

In a yet further aspect the formwork of the invention, when comprised of an indefinite length of a flexible, corrugated material, is formed from a stiff flexible plastics material.

### PREFERRED EMBODIMENT

The description of the invention to be provided herein is given purely by way of example and is not to be taken in any way as limiting the scope or extent of the invention.

Throughout this specification, unless the text requires otherwise, the word “comprise” and variations such as “comprising” or “comprises” will be understood to imply the inclusion of a stated integer or step or group of integers or steps but not the exclusion of any other integer or step or group of integers or steps.

### DRAWINGS

FIG. 1: is a perspective view of a prototype channel unit according to the invention.

FIG. 2: is an end elevation view of a moulded item of formwork.

FIG. 3: is a plan view 300 of a moulded item of formwork.

FIG. 4: is a side elevation view 400 of part of a moulded item of formwork.

FIG. 5: is a perspective view of a complete item of formwork.

FIG. 6: is a perspective view of a quarter-circle prefabricated item of formwork.

FIG. 7: is a perspective view of a 45 degree corner item.

FIG. 8: is part of an item of formwork illustrating some possible edge formations.

FIG. 9: illustrates an item comprising a short straight length including an incline (or decline).

FIG. 10: illustrates an item comprising a straight length including a corner at one end.

FIG. 11: illustrates another version of modular formwork using sacrificial pegs used to locate edging, and re-usable shutters.

FIG. 12: as 12a and 12b illustrates a variation of the formwork based on a corrugated, hence bendable yet rigid configuration.

FIG. 13: as 13a and 13b illustrates rollers useful for finishing the top surface of the concrete poured into the pre-formed edging.

FIG. 14: illustrates an “X” connection for making intersecting edging.

FIG. 15: illustrates a “T” connection for making intersecting edging.

FIG. 16: illustrates another version of modular formwork for making curved edging comprising short straight sections.

### EXAMPLE 1

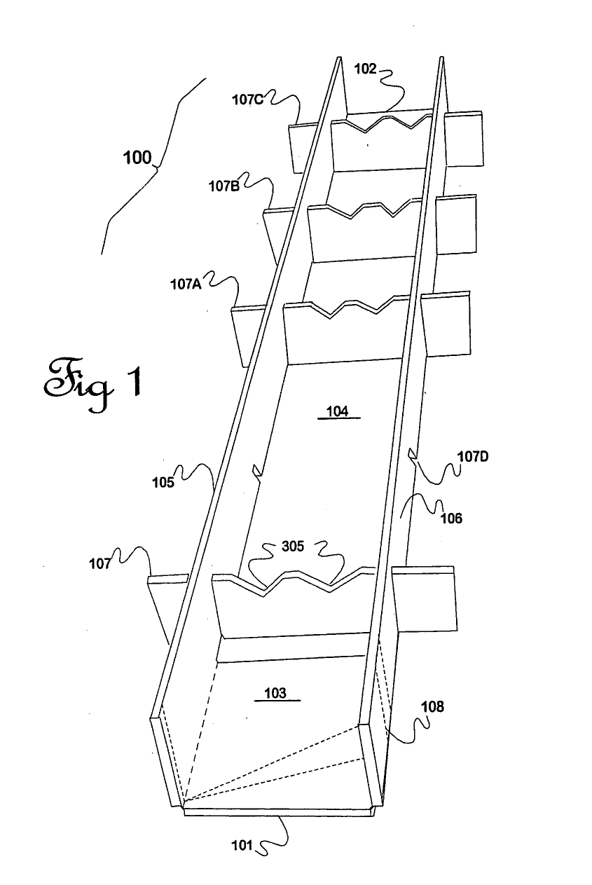

The principle of this invention—that of providing pre-formed, mainly sacrificial types of formwork for creation of landscape edging—is maintained through a number of examples which teach the invention in different embodiments. The inventors assume that the majority of demand for their invention will comprise guiding units that are either about 140 mm wide, or 250 mm wide, (that is, space between walls 105 and 106 of FIG. 1) to be used by landscapers or private persons when dividing an area into portions serving different purposes such as lawns or gardens. (It is important to note that those sizes are given by way of example only. The above dimensions are selected only as being suitable for use as a base for walls using standard brick sizes. There are of course many other possible convenient dimensions, depending for example on the primary objective of the edging which may for example be as a concealed way to carry water, electricity or communications about an area, or a barrier to weeds).

The invention provides prefabricated shuttering or “formwork” that will hold poured concrete (or other settable material such as mortar) in place in elongated horizontal beam form until it has been cured, and which can optionally locate one or more bars of internally located reinforcing iron (and possibly also water pipes or electric cables for distribution about a garden) within the horizontal concrete beam.

Further, the invention provides formwork that will disappear in time. Preferably it can be torn or cut from areas of the edging where it remains exposed, or optionally it is made of a degradable or biodegradable material that will rust, corrode, or rot away in time. (Alternatively the formwork can be regarded as “decorative” in its own right.

FIG. 1 shows an early prototype channel unit 100, having ends 101 and 102. It comprises a U-shaped piece of partly cut and then bent planar material conveniently made of a polypropylene stiff yet light-weight material known as “flute board” although the same principles of construction can be applied to alternative materials to be described below. The sides of the “U” are walls 105 and 106 and the floor is 103. However the floor may be virtual as shown by cut-out aperture 104 and one purpose of this large aperture is so that the concrete can reach to the solid bottom of the trench. If the weight of the concrete was to be supported by the channel unit as it bridges a gap, the channel unit might fail (assuming the preferred materials are used). Preferably some parts of the floor of the “U” are left intact such as at the ends 102, 103 and perhaps also in the middle. These provide strength and stop the channel unit from collapsing like a parallelogram. Aperture areas for any of the Examples described herein are typically from between about 15% to about 65% of the total base area (100% in the case of Example 5 as described below). The intact floor sections may be useful for the purpose of cutting the channel unit to fit into a defined length. The invention also provides pre-printed cutting guides as the dotted lines (shown here at 108 and printed at intervals of for example 100 mm along the length of the channel unit, so that an installer can mitre angled joints such as 60 and 90 degree joints by cutting along the lines. A number of transverse clips 107, 107A, 107B, 107C, 107D have been inserted in the channel unit. (The one at 107D is missing). Each of these provides typically 3 valleys, or any number from 1 up to 5 or more valleys across the top, into each of which which a straight item such as a beam of reinforcing iron or a water pipe may be laid. The clips also provide transverse strength.

After the concrete has poured and hardened (cured), any channel unit material that is or may become visible can be torn away, or cut away with a knife.

After a suitable curing period (or possibly very little curing, optional block work may, if desired, be laid on top. This includes the commonly preferred fired-clay bricks.

If reinforcing iron has been used the concrete edging should (after curing) be strong enough to bear the weight of a passing vehicle without breakage.

### EXAMPLE 2

The invention has proceeded towards establishing suitable constructional materials that are economical to produce yet are sufficiently strong to withstand forces imposed during construction. Wooden or metal materials may be considered but carry significant cost and fabrication penalties. It is useful to consider other manufacturing options, particularly those employing other kinds of plastics material that are formed into shapes visually or functionally similar to those outlined in Example 1 by methods known to those skilled in the art, some of which are reviewed here.

Vacuum forming (also called thermoforming). This method of shaping flat sheets of a thermoplastics material appears to be particularly suited to the present invention. The descriptive name also includes pressure forming, and generally comprises the forcing by gas pressure (that is, including use of a vacuum inside the mould or gas pressure applied from outside, or both) of an originally flat sheet while hot and soft into a previously shaped, re-usable mould, so that the sheet adopts the shape of the mould, then turning the finished article out after it has hardened sufficiently. The thin material cools quickly so that the mould can be re-used. Some stretching of the sheet occurs while it is being formed. Preferably, the product walls are provided with corrugations during during the forming process, for extra strength. Polystyrene sheet is one common example of a commonly used thermoplastics material. Supplies of recycled polystyrene are available for this purpose, in a preferred black colour, which is less obtrusive in a garden setting if exposed and not removed. Polystyrene/rubber, or other recycled plastics plus rubber compositions may be useful. For lower labour input, a material permitting degradation (rotting, corrosion or disintegration) of the sides after the settable material has cured sufficiently is used. This material includes certain biodegradable plastics and may be a cellulose-based material such as a paper pulp or papier mache material that is slip-cast or pressed or otherwise formed by techniques in use for such materials. Alternatively the sides are formed of a material permitting hand or machine tearing, cutting or stripping of the sides or at least that part visible above the substrate, and might include weakened tear lines cut into each item of formwork.

Examples of guides for landscaping produced by this method are as shown in FIGS. 2 to 10. The inverted “U” shapes are consistently provided in channel units manufactured in this way; whether intended for straight, curved or bent runs of edging.
1) Rotational moulding forces material into a previously shaped, re-usable mould often made of cast aluminium by centrifugal force. Suitable plastics include without limit low, medium and high density polyethylene, polypropylene, polyamides (nylons), polyvinyl chloride, etc. The method appears to be tolerant to the use of recycled plastics which may not be as pure as the original plastics. Again, black is a preferred colour. The plastics are commonly introduced into the mould as ground, pulverised or powdered raw materials.
2) Blow moulding is another option for forming shapes, though it is more applicable to closed containers. A blow moulded container of suitable dimensions could be cut in half to form two “U”-shaped channels according to the invention.
3) Injection moulding, including co-moulding with metal stiffeners, is a widely used technique elsewhere. The filling material is hot enough to flow and under high pressure, unlike the previous methods, so that the moulds are more costly than for the previous examples which are carried out at more or less atmospheric pressure. A very wide range of the thermoplastics and some thermosetting materials (if introduced before the cross-linking reaction) are available for this process, as is well known to workers in the art, but there is a risk with recycled plastics that contamination may be abrasive to injectors and dies when used with this technique.
4) Moulding of polystyrene foam shapes, starting with dense grains that expand when exposed to the temperature of the mould, is another option.
5) Extrusion forming is widely used such as for spouting along roof edges, and could be adopted for the present invention at least for straight runs. Cross bridges could be produced by deformation when the material is still hot, or could be separate pieces, glued or ultrasonically welded or RF-welded into place.
6) A roll of flat metal strip of indefinite length, perhaps about 250-350 mm wide, could be fed through a forming machine (consisting of at least one set of co-operating rollers) that can form the metal strip into a “U” shape with turned-over edges (for screeding) in a similar manner to those forming machines that make copper spouting from flat copper strip material. Corrugations could be added. It would be relatively difficult to form the internal cross members that support the preferred length or lengths of reinforcing material, plus optional pipes or cables, but these may be supported on wire forms that, when dropped into the “U” shaped channel as it lies on the ground, support the inserts at about 50 mm (2 inches) above the base of the channel.
7) Metal shapes for use as edging strips, having shapes like the vacuum-formed examples described above, may also be formed by pressing sheets between dies. This method has the advantage that there are standard procedures, well-known in the art, for impressing corrugations or the like into the product in order to stiffen a plain (flat-sheet) shape, so that a desired amount of stiffness can be obtained with thinner, lighter, and less costly material. It would be possible to use steel or aluminium sheet of a thickness from about 0.2 (like a foil) to 1 mm or more in this application.
8) Use of formwork based on the structure of corrugated plastic piping (see Example 3). The inventors propose to adapt the overall shape of the existing material by commencing with manufacture of either a square-sectioned pipe that is cut along its length into two halves, each of which resulting halves has a relatively stiff (in section) “U”-shaped profile yet is flexible along its length and may be used in the same manner as previously described edging, or to commence with manufacture of a “U”-shaped profile in the first instance. The range of dimensions proposed are similar to those described elsewhere in this specification. One advantage of this material is that the lengthways flexibility applies to both horizontal and vertical axes and hence a user has relatively more freedom to conform to existing topography. A second advantage is that the transverse dimensions at a bend are hardly altered at the bend, although with some other materials compression may be seen at a bend caused for reasons such as buckling of the inner radius or stretching of the outer radius. The material may be supplied in rolls of any convenient length. The corrugations allow the piping to behave as if it was made of a series of bellows.

FIGS. 2 to 10 show examples of vacuum-formed moulded formwork items according to the invention. It should be noted that dimensions are not prescribed in this specification. It may be convenient to base garden edging dimensions on standard brick sizes while the invention may be scaled up or down for other applications. In FIG. 2, the base 201 (including some strengthening ridges 204) would be laid upon the ground, or in a shallow trench, ready to accept concrete. This example has sloping sides 202, 203 of use when shipping the product, because items may be nested inside each other. The sides terminate in bent-over tops 205, 206 having mainly strengthening attributes but also of use when levelling (screeding) the poured concrete. Inside the example item of formwork, periodic cross-bridges 207 cut across the interior—but only partially, so that the resulting concrete beam will not be fully interrupted. (In one variation the cross bridges do reach to the full height of the concrete and hence provide interruptions of use when the concrete shrinks as it cures). In order to maintain the continuity of the concrete, apertures 211 are provided under the bridges along the length of the moulded item. The bridges provide strength by preventing the side walls from diverging when filled, and they support a variety of elongated structures (such as reinforcing bars of steel, water pipes, or electric cables) on top of the bridges, within the valleys 208, 209, 210. Such structures can be tied in place or simply placed in the valleys before pouring the concrete. Clearly it is inadvisable to rely on an electric cable alone for structural reinforcement, but a cable can be used in combination with at least one steel reinforcing bar. The use of only low-voltage (garden lighting purposes) or residual-current-detection protected wiring is recommended in case of leakage of hazardous current from unintentional breaks. Use of reinforcing bars may give the cured concrete sufficient strength to withstand the weight of road vehicles, which it would not have had without any embedded tensile members.

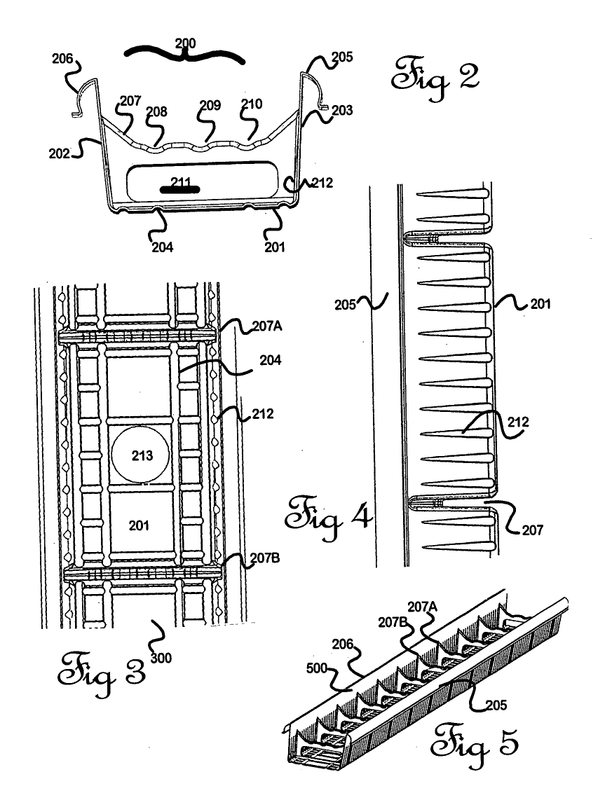

The plan view of FIG. 3 shows an area between a first cross bridge 207A and a second cross bridge 207B, with rectangular strengthening ribs in the floor 204 and in the walls 212. Apertures such as 213 are cut or otherwise formed through the floor along the length of the moulded item in order to let concrete fall through—as previously discussed in relation to hole 104 in FIG. 1. FIG. 4 (which is displayed on end, with the base 201 at the right and the top edge 205 at the left) shows (a) that the reinforcing ribs (212) within the wall are repeatedly present, and (b) that cross bridges 207 represent voids across the width of the item. Clearly, apertures 211 will also allow concrete to reach the space beneath the item of formwork, as do apertures 213 (not shown in FIG. 4.) FIG. 5 shows a perspective view of an entire straight unit according to the invention, having 11 cross bridges. Each unit is sufficiently flexible to be mated end-to-end with like units so that an edging of any specified length can be made. The material can be cut as required, such as with a knife, to fit plans or existing structures or areas.

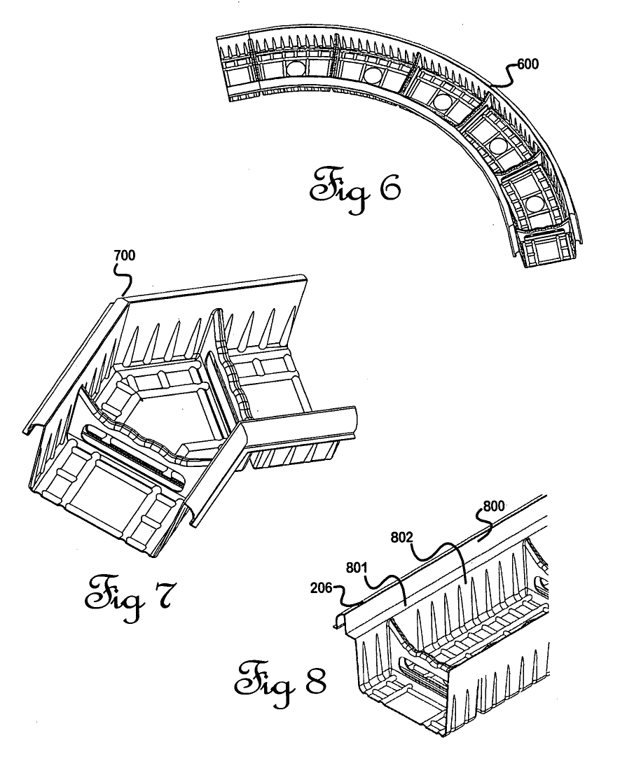

FIG. 6 shows a part-circular bend 600 which runs through a 90 degrees arc of a circle. This is an example bend, and other examples with different amounts of arcs and radii of the bend may be made and supplied, or cut on the job. Component parts of this item are as previously described in relation to FIGS. 2-5 and the cross-bridges in particular are evident. FIG. 7 shows an example sharp corner 700. This is a 45 degrees corner (elbow) and component parts of this item are as previously described in relation to FIGS. 2-5. Corners (elbows) having other common angles such as 30, 45, 60 and 90 degrees (or any other angles) can be moulded and stocked for sale. These degrees mentioned are of course given by way of example only.

In the FIG. 8 example, non-symmetrical edging is shown. One side 800 is offset to one side of the axis of the moulded item by a step 801. This option may (for example) be useful when laying concrete blocks on top of the edging and after a concrete beam has been formed and at least partially cured within the body 802 of the moulded item. The invention may have one wall higher than the other, for reasons including ensuring that the top surface is not horizontal, and is thereby drained. Finished concrete edging may include a longitudinally trowelled or rolled (see FIGS. 13a and 13b) or otherwise formed channel within the top of the concrete surface so that water is carried along the course of the edging. This example has no finish at all (such as folding) on the other side 803.

FIG. 9 shows a short section 900 of a moulded edging which includes an inclined section between 901 and 902, suitable for use where the land includes a rise (or a fall). This example could be described as being curved about a horizontal axis, whereas FIG. 6 is described as being curved about a vertical axis). Other amounts of change of orientation may be made according to the illustrated version according to the invention. Example 900 is for use where the incline is gradual. A person installing edging may cut the inclined section between 901 and 902 and join in straight sections of any required length, or join two inclined sections together in order to have twice the deviation in slope.

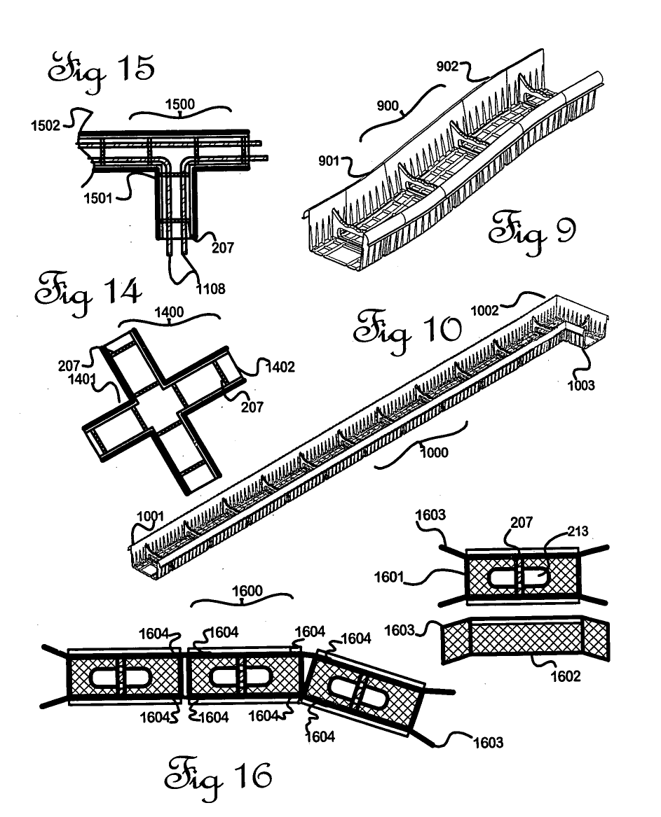

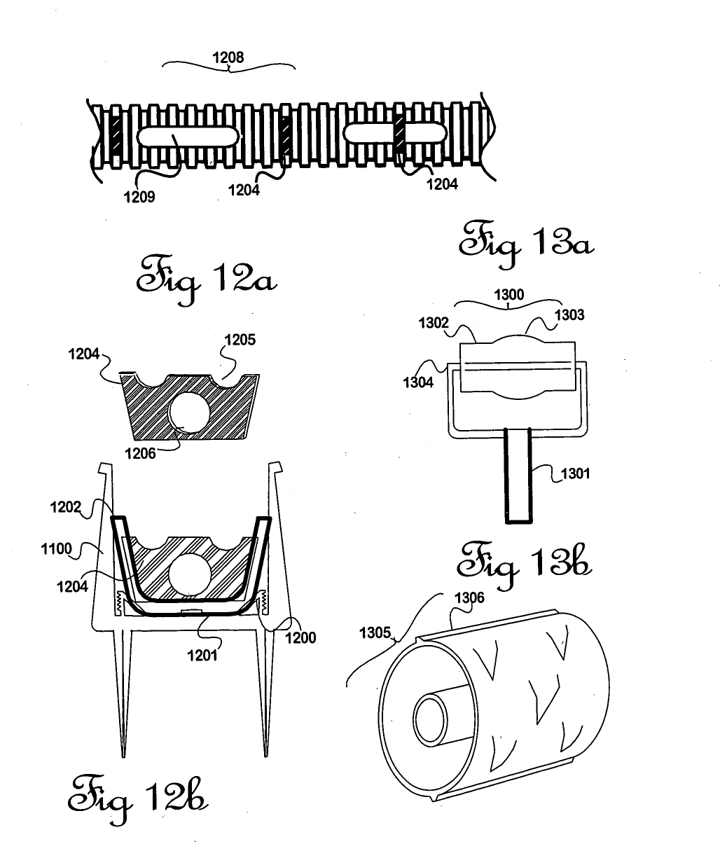

It is sometimes convenient to combine a curved or elbow section with a straight section during moulding, as in the example 1000 of FIG. 10. In this example, a relatively long straight section between 1001 and 1002 is moulded and provided with a 90 degrees corner on one end, finishing in an open end at 1003. Although we have shown one specific example, curved or elbow sections may be made in any angle of deviation as previously described. Mirror images are also provided because of the asymmetry involved. It would be possible to construct an edging around a small flower garden with two bent sections as shown in FIG. 10, and perhaps two straight sections, or more, depending on the actual dimensions. “T” or “Y” or “X” junctions can be moulded in a similar way and might be made of a stronger grade of material in order to cope with extra strain during construction. FIG. 14 shows at 1400 an “X” junction in plan view, with bridges 207 crossing the interior. A perpendicular crossing is shown at 1401. The “X” junction is shown provided without a long arm (as FIG. 10), but a long arm may be included. In FIG. 15, a “T” intersection is shown with a long arm indicated at 1502. Lengths of reinforcing iron (1108) supported on cross-bridges 207 that go around the bend are included in this drawing. Alternatively, a side opening may be cut by an installer into a side of a moulding in order to create a junction, although with some risk of a poorer finish.

### EXAMPLE 3

An alternative plastics material is similar to a moulded flexible drainage pipe made for example of a black-coloured polyethylene or polyvinyl chloride plastics material, of circular cross-section having a corrugated or bellows-like wall along substantially the entire length. One example is sold in New Zealand under the brand “NOVAFLOW”. This material comprises a series of circular rings or a continuous spiral all joined sideways to each other. The resulting pipe is relatively flexible, like a bellows, along its length although surprisingly rigid under radial compression and is widely used after burial in shallow trenches in the drainage of soil, where the pipe is provided with a plurality of slits in the wall for the admittance of surplus ground water. The range of dimensions proposed are similar to those described elsewhere in this specification. One advantage of this material is that the lengthways flexibility applies to both horizontal and vertical axes and hence a user has relatively more freedom to conform to existing topography. A second advantage is that the transverse dimensions at a bend are hardly altered at the bend, although with some other materials compression may be seen at a bend caused for reasons such as buckling of the inner radius or stretching of the outer radius. The material may be supplied in rolls of any convenient length.

Example 3 retains the concept of the circumferential corrugations, while adapting the overall shape of the existing material into a “U” shape as shown in plan view at 1200 in FIG. 12a. According to the invention, either a square-sectioned pipe is made and then cut alongth into two halves, each of which has a relatively stiff (in section) “U”-shaped profile yet is flexible along its length and may be used in the same manner as previously described edging, except that this version allows curves and inclines to be made as and when required, rather than relying on supplied pre-formed curves. Alternatively a “U”-shaped profile with edges and transverse deep corrugations is made such as by the vacuum forming process that was described earlier. An insert 1204 may be wedged into the space where a wider portion of the pipe exists as shown within the elevation view in FIG. 12b, in order to carry reinforcing material, pipes or cables within the depressions 1205 formed within the top section. Two depressions are shown along the upper surface of the insert; from 1 to 6 or more may be used. Aperture 1206 admits concrete (as previously described) in order to maintain the integrity of the reinforced concrete beam. A plan view of some straight edging according to this aspect of the invention is shown at 1208. Here, some elongated holes 1209 have been cut into the base of the “U” section in order to let concrete when poured access the ground below. The range of dimensions proposed are similar to those described elsewhere in this specification. One advantage of this material is that the lengthways flexibility applies to both horizontal and vertical axes and hence a user has relatively more freedom to conform to existing topography. A second advantage is that the maximum sharpness of bends is inherently limited. A further advantage is that the transverse dimensions at a bend are hardly altered at the bend, in contrast to some other materials where compression may be seen at a bend caused for reasons such as buckling of the inner radius or stretching of the outer radius. On the other hand this flexibility may mean that the material will not remain where it is placed particularly if it is not placed in a shallow trench, and a support peg 1100 as described more fully in the following section may be used to hold the material in place until it is filled with wet concrete. This support peg is shown as dashed lines in FIG. 12, and a two-spike version is illustrated. The slight outward slope of the “U” section allows this material to be packed relatively tightly by either stacking short lengths on top of each other, or by coiling a long length on to a reel. If short sections are used they may interlock with each other when forming end-to-end joins.

### EXAMPLE 4

Another “flexible” version of the invention is shown in FIG. 16. This comprises a number of short “U”-shaped vacuum-formed channel units 1601 (plan view and 1602 (elevation view) having extended vertical side walls 1603, internal cross-bridges 207 and apertures 213. These 4 units are laid down as a chain of interlinked segments as at 1600. Each segment can be joined 1604 (stapled or glued, for example) to its neighbour by the extended side walls at each side at the installation site; the limited variation allowing the chain of segments to form straight lines or to approximate curves about a vertical or a horizontal axis, and in any direction. Any opening that appears in the base between non-aligned segments simply allows concrete to bleed into the space beneath the formwork and the ground below as it will in any case, through aperture 213. An advantage of this version is that less stock needs to be carried and fewer moulds need to be made.

### EXAMPLE 5

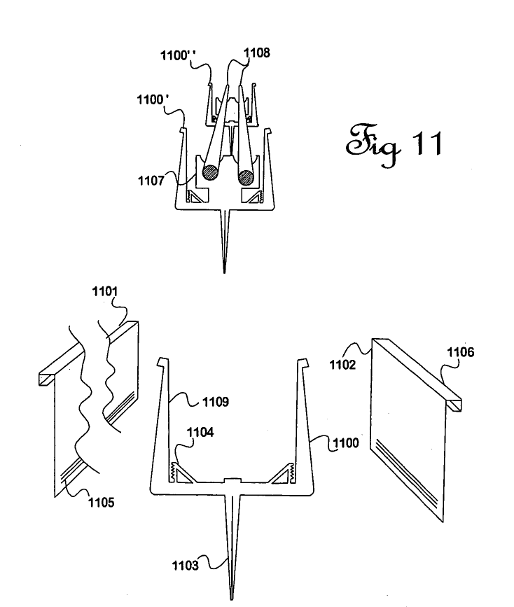

In an alternative version of this invention as shown in FIG. 11, the invention provides a series of re-usable shutters 1101, 1102 to be placed along a garden edging, to hold the concrete in place while it sets. The shutters are clipped or placed within the vertical projections 1109 each of a series of preferably injection-moulded support pegs 1100 that will be sacrificed. Each peg 1100, 1100′ and 1100″ is pushed into the ground at a spacing of perhaps 1 foot (25.4 cm) apart along the track of the edging. The pegs include one (or more) spikes 1103 that penetrate the soil. Each peg preferably includes at least two shutter retention means—in this example a ridged section 1104 that engages with corresponding ridges 1105 along each shutter, although the ridges (if used at all) should not be so large that they lock into the hardened concrete. Each shutter may be made for example of pressed and folded metal, or plastic, or wood. It is intended that the shutters can be removed and re-used. In one version the shutters are short (like shutter 1102) and the shutters can be joined end to end either inside the pegs or between them. In another version (as indicated in 1101) the shutters are relatively long. The top edge of the shutters may be folded over as shown at 1106 in order to provide both stiffness (absent from prior-art formwork of this type) and a surface on which a screeding edge can be supported when the concrete is being finished, or the folded over portion may be deleted so that the shutter can be bent around a vertical axis. The pegs are preferably made to also include support means 1107 for reinforcing bars 1108 as shown in the pegs 1100′ and 1100″. In one option the support means 1107 can be broken off if desired.

### EXAMPLE 6

This Example refers to rollers for finishing the exposed surface of the wet concrete or mortar with functional or decorative patterns. FIG. 13a shows a hand-held roller 1300 useful with any version of the preformed edging described in this specification. It is used for forming a shallow groove or channel in the upper surface of the wet concrete so that the edging serves to carry any water along the line of the edging towards a lower point. The channel-forming roller includes a handle 1301, a frame 1304, and a straight section of a roller 1302 surmounted by a projecting curved section 1303. Preferably the roller is either made of, or is coated with a plastics material to which concrete (or mortar) does not stick, so that a good finish is easily obtained, and one suitable plastics material is polyteterafluorethane (Teflon®). Injection moulded plastics, or die-cast metal may for example be used. FIG. 13b shows a perspective view of another roller 1305, intended to imprint brick-like outlines on the exposed surface of wet concrete. Ridges 1306 leave impressions resembling lines of mortar. For simplicity, a paint roller handle may used with a roller according to the shape of roller 1305.

### VARIATIONS

Other plastics materials, wood, or cardboard may be used for the structures, and could be made from several lengths joined together or could even be milled from solid beams as per the existing method for making mouldings from timber. Biodegradable material, such as material developed from corn/wheat/potato starch or similar or cellulose such as papier mache may be used. (The price of plastics obtained from the petrochemical industry may rise substantially). If degradable materials are used, the beam will shift slightly as the supporting material becomes degraded and disappears.

### INDUSTRIAL APPLICABILITY AND ADVANTAGES

The invention provides a well-controlled edge to a concrete edging as used in a garden, landscape, park or playground and the result is reasonably permanent.

The invention is plant-impervious (unlike a row of bricks for example), useful if invasive plants or weeds or the like are spreading in the lawn and are to be excluded from a garden.

The invention can be used along a fence line to impose a “no-grow” strip for example, and the channel units can be dropped down over the fence posts so that they are already aligned along the fence line. (This is useful on farms, also, to restrict the chance of an electric fence being shorted by grass growing beneath).

The shuttering material provides an economical yet permanent edging.

The ability to include reinforcing iron for added strength is an advantage over for example concrete extrusion machines. Cracked and broken concrete edging, commonly seen with extruded type edgings, looks bad and is not easy to replace. The present invention should be able to withstand the weight of a vehicle tyre if properly reinforced.

There is no requirement for a haunching form of construction in which the uppermost surface is supported on sloping sides of concrete; a procedure that consumes much more concrete than the present invention. According to the present invention, about 200 lineal feet of edging can be obtained from a cubic yard of concrete, or about 80 lineal metres from a cubic metre of concrete.

The materal that is sold is light in weight, while the heavy component (the concrete or mortar) is obtained locally.

Shipment of the shuttering material is economical since it can be packed for travel as light-weight nested stacks of tapering items, plus bags of connecting components or internal bridges if required.

The layout of the edging can be reviewed in situ after placement by the site owner but before any concrete is poured or steel is placed, which is useful when the job has to satisfy aesthetic requirements rather than a building specification or plan.

Finally, it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

We claim:

1. Formwork for a settable fluid material, wherein the formwork includes a channel unit having a generally U-shaped cross-section comprised of a base and two sides extending upwardly from the base, and including at least one bridge arranged in use to extend transversely across the channel unit between the two sides.

2. Formwork as claimed in claim 1, wherein the formwork includes a plurality of said channel units, wherein each channel unit has at least one open end, and the ends are engageable to define a continuous channel along a plurality of said units.

3. Formwork as claimed in claim 1, wherein the two sides have top edges and the bridge has a top surface, the top surface being entirely below the top edges, so that in normal use the bridge can be entirely immersed in a settable fluid contained between the sides.

4. Formwork as claimed in claim 1, wherein the two sides have top edges and the bridge has a top surface, the top surface being at a level substantially the same as that of the top edges, so that in normal use the bridge can serve as a crack former during curing of the settable fluid material.

5. Formwork as claimed in claim 3, wherein the formwork includes at least one aperture under each said bridge between the top surface of the bridge and the base of the channel unit, so that in normal use settable fluid contained within the channel unit can flow under the bridge and merge with settable fluid beyond the bridge.

6. Formwork as claimed in claim 3, wherein the top surface of the bridge is notched, to, in normal use, seat at least one elongate beam extending along and parallel to the channel unit.

7. Formwork as claimed in claim 1, wherein the bridge comprises an integrally formed component of the channel unit.

8. Formwork as claimed in claim 1 wherein the or each bridge comprises a separate element engageable with the channel unit or conforming to the interior of the channel unit.

9. Formwork as claimed in claim 2 wherein the formwork includes at least one elongate channel unit having two open ends facing in opposite directions, defining a substantially straight channel between said ends.

10. Formwork as claimed in claim 2 wherein the formwork includes at least one corner channel unit having two open ends, one said end being arranged tangentially with respect to the other.

11. Formwork as claimed in claim 10, wherein the corner channel unit is comprised of a first substantially straight section having two open ends; the first section having a second section joined to the first section between the open ends so that a “T” junction having a third open end is provided.

12. Formwork as claimed in claim 10, wherein the corner channel unit is comprised of two substantially straight sections joined tangentially so that a sharp elbow or corner is formed; the corner channel unit having two open ends, one said end being arranged at an angle in a range of from about 30 degrees to about 120 degrees to the other.

13. Formwork as claimed in claim 10, wherein the corner channel unit is curved about a substantially vertical axis; the corner channel unit having two open ends, one said end being arranged at an angle in a range of from about 15 degrees to about 120 degrees to the other.

14. Formwork as claimed in claim 10, wherein the corner channel unit is curved about a substantially horizontal axis; the channel unit having two open ends, one said end being arranged at an angle in a range of from about 5 degrees to about 45 degrees to the other.

15. Formwork as claimed in claim 1, wherein the base and sides of the channel unit are formed from a flexible, corrugated material, so that in use the corrugations can be compressed together on one side of the channel unit and stretched out on the other, to flex the channel unit about an axis yet maintain a substantially constant width between the sides of the channel unit.

16. Formwork as claimed in claim 1, wherein the base and sides of the channel unit are formed from a chain of interlinked segments, each segment having at least two walls extended lengthwardly thereby permitting attachment to adjacent segments, and thereby allowing tilting of one segment in relation to an adjacent segment, so that in use the chain of segments can be assembled as a channel unit yet may curve in horizontal or vertical axes.

17. Formwork as claimed in claim 1, wherein the base and sides of the channel unit are located prior to hardening of the settable fluid material by being placed within a shallow trench cut into a substrate.

18. Formwork as claimed in claim 1, wherein the base and sides of the channel unit are located prior to hardening of the settable fluid material by use of a plurality of holding frames placed on or in the substrate.

19. Formwork as claimed in claim 1, wherein the base of the channel unit includes at least one aperture, so that when in use part of the settable fluid material can flow out through the base and form a contact with the substrate, thereby relieving the formwork of the weight of the settable fluid material.

20. Formwork as claimed in claim 1, wherein the base of the channel unit includes at least one aperture, so that the channel unit may be fixed on to the substrate.

21. Formwork as claimed in claim 1, wherein the sides have shapes permitting subsequent removal of the sides after the settable material has cured sufficiently.

22. Formwork as claimed in claim 1, wherein the sides are formed of a material capable of degradation after the settable material has cured sufficiently

23. A method for creating an edging, wherein the method includes the steps of:
a. Laying out a course along a substrate along which the edging is to run;
b. fitting formwork into the course, the formwork comprising a channel unit having a generally U-shaped cross-section comprised of a base and two sides extending upwardly from the base, and a plurality of bridges extending between the sides, above the base,
c. and pouring a settable fluid material into the formwork to fill the channel unit above the level of said bridges.

24. A method as claimed in claim 23, further including the step of placing at least one elongate member along said bridges before pouring the settable fluid material, to a level above the level of the bridges and the elongate member or members; the elongate member or members being selected from a range including (a) reinforcing steel bars, (b) pipes, and (c) electrical or optical cables.

25. A method as claimed in claim 23, further including the step of removing at least an upper part of the sides after the fluid material has set.
